(19) United States
(12) Patent Application Publication
(10) Pub. No.: US 2006/0224643 A1
(43) Pub. Date: Oct. 5, 2006

(54) Identifying objects that are obscured in the visible name space of a file system

(75) Inventors: Timmothy Scott Carlson, Rochester, MN (US); Richard Michael Theis, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/094,656

(22) Filed: Mar. 30, 2005

(51) Int. Cl. G06F 17/30

(52) U.S. Cl. 707/205

(57) ABSTRACT

Methods, apparatuses, systems, and computer program products are provided for identifying objects that are obscured in the visible name space of a file system that include retrieving a data structure representing a mounted-over object in the visible name space of the file system, retrieving a data structure representing that the mounted-over object is mounted over a covered object that is obscured in the visible name space in dependence upon the data structure representing the mounted-over object, and retrieving a data structure representing the covered object in dependence upon the data structure representing that the mounted-over object is mounted over the covered object. Some embodiments also include creating a GUI display object representing the covered object; and displaying the GUI display object.

### BACKGROUND OF THE INVENTION

1. Field of the Invention

The field of the invention is data processing, or, more specifically, methods, systems, and products for identifying objects that are obscured in the visible name space of a file system.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. The most basic requirements levied upon computer systems, however, remain little changed. A computer system's job is to access, manipulate, and store information. Computer system designers are constantly striving to improve the way in which a computer system can deal with information.

Computers have a foundation layer of software called an operating system that stores and organizes files and upon which applications depend for access to computer resources. In an operating system, the overall structure in which objects such as files are named, stored and organized is called a file system. File systems are often organized in a name space and the objects stored in the file system are accessed through a pathname. A pathname is a sequence of symbols and names that identifies a file. Every file in the name space has a name, called a filename, so the simplest type of pathname is just a filename. To access files in directories, a pathname identifies a path to the file starting from a working directory or from a root directory to the file. Various operating systems have different rules for specifying pathnames. In DOS systems, for example, the root directory is named \, and each subdirectory is separated by an additional backslash. In UNIX, the root directory is named /, and each subdirectory is followed by a slash. In Macintosh environments, directories are separated by a colon.

Operating systems also typically provide graphical user interface objects (“GUI”) to visually display the name space. Such visual displays of the name space provide users with a display of the pathnames of the file system. Often such displays provide collapsible GUI display objects that allow to a user to navigate through the pathnames of the file system.

Files are made available to processes on the operating system by mounting the files to a location in the file structure of the file system. This location in the file structure is called a mount point. If an object such as a file is mounted at a mount point in the name space that is currently used to identify another object, then mounting the object obscures the other object located at the same mount point. That is, the current object at the mount point is obscured because the current object can no longer be accessed by use of a pathname in the name space and the current object is no longer visible in a display of the pathnames of the file system.

The obscured object is not removed from the memory managed by the file system. The obscured object is simply no longer accessible through the name space. To retrieve such obscured objects, conventional file systems require unmounting the object that is accessible with the pathname to reveal the obscured object. Performing such an unmount may be time consuming. Furthermore, obscured objects may also be dangerous to a computer. For example, a computer virus may be obscured by unmounting a collection of files, mounting the virus, and then re-mounting files to obscure the virus from the visible name space.

### SUMMARY OF THE INVENTION

Methods, apparatuses, systems, and computer program products are provided for identifying objects that are obscured in the visible name space of a file system that include retrieving a data structure representing a mounted-over object in the visible name space of the file system; retrieving, in dependence upon the data structure representing the mounted-over object, a data structure representing that the mounted-over object is mounted over a covered object that is obscured in the visible name space; and retrieving a data structure representing the covered object in dependence upon the data structure representing that the mounted-over object is mounted over the covered object. Some embodiments also include creating a GUI display object representing the covered object and displaying the GUI display object.

Identifying objects that are obscured in the visible name space of a file system may also be carried out by retrieving a data structure representing a mount in dependence upon a mount ID and retrieving a data structure representing a covered object that is obscured in the visible name space in dependence upon the data structure representing the mount. Some such embodiments also include creating a GUI display object representing the covered object and displaying the GUI display object.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system of computers each of which may have installed upon it a file system capable of identifying objects that are obscured in the visible name space according to embodiments of the present invention.

FIG. 2 sets forth a block diagram of automated computing machinery comprising an exemplary computer useful in identifying objects that are obscured in the visible name space of a file system according to embodiments of the present invention.

FIG. 3 sets forth a flow chart illustrating an exemplary method for identifying objects that are obscured in the visible name space of a file system.

FIG. 4 sets forth a block diagram of a GUI display of the visible name space of a file system whose covered objects are identified and displayed according to embodiments of the present invention.

FIG. 5 sets forth a flow chart illustrating another exemplary method for identifying objects that are obscured in the visible name space of a file system.

### DETAILED DESCRIPTION OF EXEMPLARY EMBODIMENTS

### Identifying Objects That Are Obscured In The Visible Name Space Of A File System

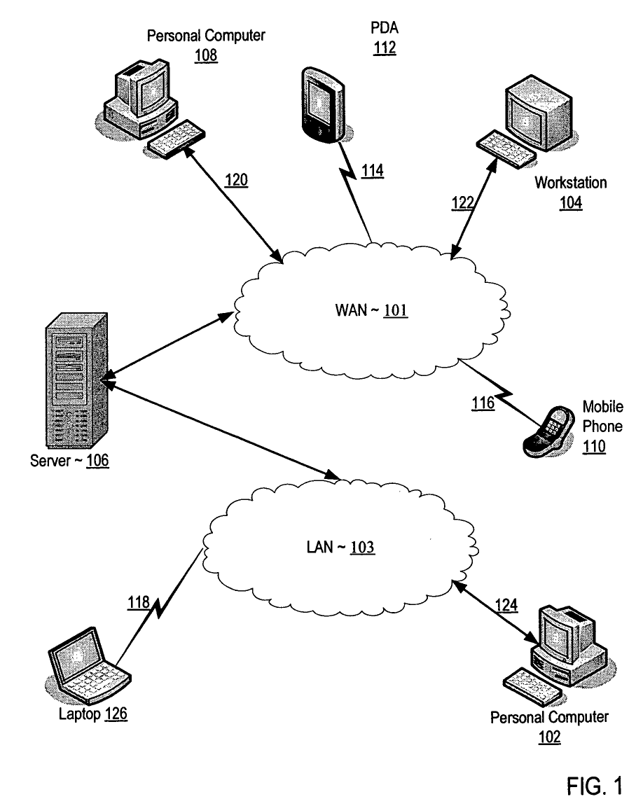

Exemplary methods, apparatuses, systems, and products for identifying objects that are obscured in the visible name space of a file system according to embodiments of the present invention are described with reference to the accompanying drawings, beginning with FIG. 1. FIG. 1 sets forth a network diagram illustrating an exemplary system of computers each of which may have installed upon it a file system capable of identifying objects that are obscured in the visible name space according to embodiments of the present invention.

The data processing system of FIG. 1 includes wide area network (“WAN”) (101) and local area network (“LAN”) (103). The network connection aspect of the architecture of FIG. 1 is only for explanation, not for limitation. In fact, systems for identifying objects that are obscured in the visible name space of a file system may be connected as LANs, WANs, intranets, internets, the Internet, webs, the World Wide Web itself, or other connections as will occur to those of skill in the art. Such networks are media that may be used to provide data communications connections between various devices and computers connected together within an overall data processing system.

In the example of FIG. 1, server (106) implements a gateway, router, or bridge between LAN (103) and WAN (101). In the example of FIG. 1, several exemplary devices including a PDA (112), a computer workstation (104), a mobile phone (110), and personal computer (108) are connected to WAN (101). Network-enabled mobile phone (110) connects to the WAN (101) through a wireless link (116), and the PDA (112) connects to the network (101) through a wireless link (114). In the example of FIG. 1, the personal computer (108) connects to the network (101) through a wireline connection (120), and computer workstation (104) connects to the network (101) through a wireline connection (122). In the example of FIG. 1, the laptop (126) connects to the LAN (103) through a wireless link (1 18) and the personal computer (102) connects to the LAN (103) through a wireline connection (124).

In the system of FIG. 1, each of the exemplary devices (108, 112, 104, 110, 126, 106, and 102) have installed upon them an operating system having a file system and an obscured object identification engine. Each of the exemplary computers of FIG. 1 includes a computer processor and computer memory coupled for data transfer to the processor. The computer memory of each of the computers of FIG. 1 has disposed within it a file system and computer program instructions comprising an obscured object identification engine. The obscured object identification engine is capable generally of identifying objects that are obscured in the visible name space of a file system by retrieving a data structure representing a mounted-over object in the visible name space of the file system; retrieving, in dependence upon the data structure representing the mounted-over object, a data structure representing that the mounted-over object is mounted over a covered object that is obscured in the visible name space; and retrieving a data structure representing the covered object in dependence upon the data structure representing that the mounted-over object is mounted over the covered object. The obscured object identification engine is also capable of creating a graphical user interface (“GUI”) display object representing the covered object and displaying the GUI display object.

The obscured object identification engine is also capable of retrieving a data structure representing a mount in dependence upon a mount ID and retrieving a data structure representing a covered object that is obscured in the visible name space in dependence upon the data structure representing a mount. Such obscured object identification engines are also capable of creating a GUI display object representing the covered object and displaying the GUI display object.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP/IP, HTTP, WAP, HDTP, and others as will occur to those of skill in the art. Various embodiments of the present invention may be implemented on a variety of hardware platforms in addition to those illustrated in FIG. 1.

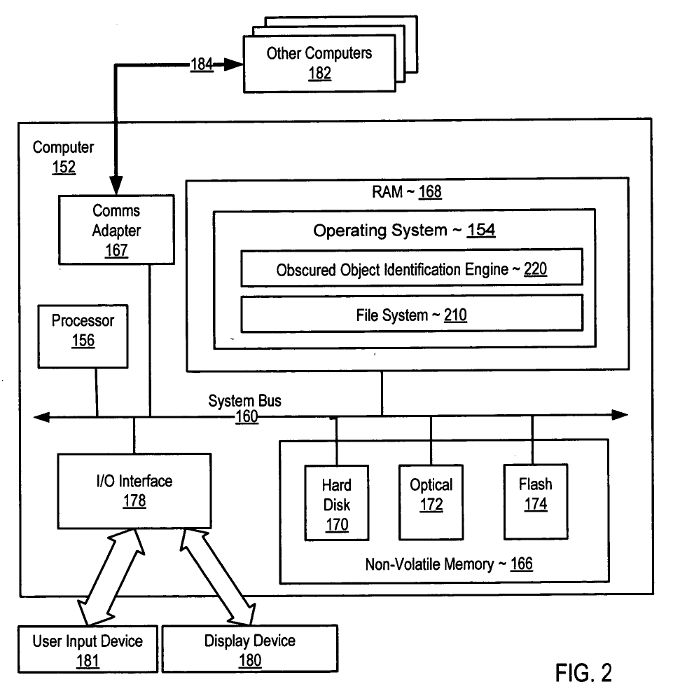

Identifying objects that are obscured in the visible name space of a file system in accordance with the present invention is generally implemented with computers, that is, with automated computing machinery. For further explanation, therefore, FIG. 2 sets forth a block diagram of automated computing machinery comprising an exemplary computer (152) useful in identifying objects that are obscured in the visible name space of a file system according to embodiments of the present invention. The computer (152) of FIG. 2 includes at least one computer processor (156) or “CPU” as well as random access memory (168) (“RAM”) which is connected through a system bus (160) to processor (156) and to other components of the computer.

Stored in RAM (168) is an operating system (154). Operating systems useful in computers according to embodiments of the present invention include UNIX™, Linux™, Microsoft NT™, AIX™, IBM's i5/OS, and many others as will occur to those of skill in the art. The operating system (154) of FIG. 2 also includes a file system (210) and an obscured object identification engine (220) that comprises computer program instructions for identifying objects that are obscured in the visible name space of the file system by retrieving a data structure representing a mounted-over object in the visible name space of the file system; retrieving, in dependence upon the data structure representing the mounted-over object, a data structure representing that the mounted-over object is mounted over a covered object that is obscured in the visible name space; and retrieving a data structure representing the covered object in dependence upon the data structure representing that the mounted-over object is mounted over the covered object. The obscured object identification engine of FIG. 2 is also capable of creating a GUI display object representing the covered object and displaying the GUI display object.

The obscured object identification engine (220) of FIG. 2 is also capable of retrieving a data structure representing a mount in dependence upon a mount ID and retrieving a data structure representing a covered object that is obscured in the visible name space in dependence upon the data structure representing a mount. The exemplary obscured object identification engine is also capable of creating a GUI display object representing the covered object and displaying the GUI display object. Computer (152) of FIG. 2 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 also includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) with other computers (182). Such data communications may be carried out through serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters include modems for wired dial-up communications, Ethernet (IEEE 802.3) adapters for wired network communications, and 802.11b adapters for wireless network communications.

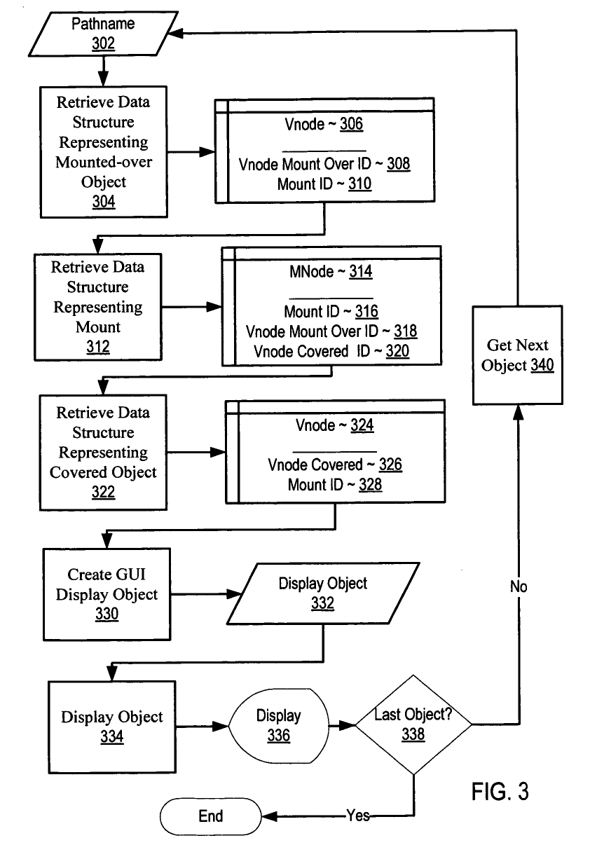

For further explanation, FIG. 3 sets forth a flow chart illustrating an exemplary method for identifying objects that are obscured in the visible name space of a file system that includes retrieving (304) a data structure (306) representing a mounted-over object in the visible name space of the file system. In the example of FIG. 3, the mounted-over object in the visible name space of the file system is identified by a pathname in the visible name space. Retrieving (304) a data structure (306) representing a mounted-over object according to the method of FIG. 3 therefore is carried out by identifying a mounted-over object by a pathname in the visible name space and retrieving a data structure representing the object identified by the pathname (302).

In the example of FIG. 3, the data structure (306) representing a mounted-over object is a Vnode. A Vnode is a record or other data structure in IBM's i5/OS operating system that stores information about a specific file in a file system. Vnodes typically contain user and group identifiers for the file, the times of the last file modification and access, a count of the number of directory entries to the file, a file type designation, pointers to the disk blocks containing the data contents for the file, as well as other information relating to the file as will occur to those of skill in the art. Retrieving a Vnode may be carried out through an operating system function call such as for example getVnode( ) parameterized with an identification of the Vnode. GetVnode( ) returns to its caller a Vnode.

Identifying objects that are obscured in the visible name space of a file system according to embodiments of the present invention are described with reference to IBM's i5/OS operating system and therefore, data structures useful in identifying objects that are obscured in the visible name space of a file system are described using their names in the i5/OS operating system. This is for explanation and not for limitation. In fact, identifying objects that are obscured in the visible name space of a file system according to embodiments of the present invention may be implemented with any operating system as will occur to those of skill in the art and using the data structures of those operating systems. In Unix, for example, data structures representing objects in the file system are called “inodes.” In Windows NT, for example, each object in a file system represented by a record in a master file table (“MFT”), and so on as will occur to those of skill in the art.

For clarity of explanation, the Vnode (306) of FIG. 3 is illustrated only with two data elements useful in identifying objects that are obscured in the visible name space of a file system according to embodiments of the present invention. The Vnode of FIG. 3 includes a Vnode Mount Over ID (308). The Vnode Mount Over ID (308) is a Vnode ID uniquely identifying the Vnode. The term ‘Vnode Mount Over ID’ is used for clarity of explanation to identify that the Vnode (306) represents a mount-over object. That is, the Vnode (306) represents an object in the visible name space that is mounted over a covered object thereby obscuring the covered object from the visible name space of the file system.

The Vnode (306) also includes a Mount ID (310) which is an identification of a data structure representing the mounting of the mounted-over object over the covered object. Data structures representing the mounting of the mounted-over objects over covered objects in the i5/OS operating system are often called ‘mount private data’ and are simple called “Mnodes” in this specification for clarity of explanation. As will occur to those of skill in the art, not all Vnodes represent objects that are in fact mounted over other objects. Therefore, if the Vnode identified by the pathname does not in fact contain an identification of an associated Mnode the object is not mounted over a covered object, and the method of FIG. 3 retrieves the next object identified by a pathname in the visible namespace.

The method of FIG. 3 includes retrieving (312), in dependence upon the data structure (306) representing the mounted-over object, a data structure (314) representing that the mounted-over object is mounted over a covered object that is obscured in the visible name space. As described above, the example of FIG. 3, the data structure (306) representing a mounted-over object is a Vnode and the data structure (314) representing that the mounted-over object is mounted over a covered object is an Mnode (314).

The exemplary Mnode (314) of FIG. 3 represents the mounting of the mounted-over object over a covered object. The exemplary Mnode of FIG. 3 includes a Mount ID (316) uniquely identifying the mount. The exemplary Mnode of FIG. 3 includes a Vnode Mount Over ID (318) uniquely identifying the Vnode of the mounted-over object and the Vnode Covered ID (320) uniquely identifying the Vnode of the covered object.

The method of FIG. 3 also includes retrieving (322) a data structure (324) representing the covered object in dependence upon the data structure (314) representing that the mounted-over object is mounted over the covered object. In the example of FIG. 3, the data structure (324) representing the covered object is a Vnode identified as a covered object that is obscured in the visible name space by the Mnode (314).

Having identified a covered object obscured in the visible name space of the file system, the method of FIG. 3 continues by creating (330) a GUI display object (332) representing the covered object; displaying (334) the GUI display object (332); and determining (338) if the mounted-over object is the last object, identified by a pathname in the visible name space of the file system. If the object is the last object, the method of FIG. 3 terminates. If there is another object identified by a pathname in the visible namespace, the method of FIG. 3 continues by getting (340) the next object in the name space and repeating the method of FIG. 3. Obscured object identification engines operating according to the method of FIG. 3 therefore retrieve a data structure representing each object in the visible name space identified by a pathname and, if there is an object obscuring a covered object, identify and display the covered object. In this manner, the method of FIG. 3 identifies all objects, in directories and subdirectories obscured in the visible name space and displays those covered objects.

The method of FIG. 3 may provide an inaccurate display of covered objects if objects are mounted or unmounted over covered objects before the completion of the method of FIG. 3. Identifying objects that are obscured in the visible name space of a file system according to the method of FIG. 3 may therefore advantageously include preventing mounts to the file system prior to retrieving the data structure representing the covered object. That is, in some embodiments of the method of FIG. 3, mounts to the file system are prevented until the method of FIG. 3 terminates. In other embodiments, mounts to the file system are prevented during each iteration of the method, which may occur periodically, thereby allowing mounts in between iterations. In still other embodiments, mounts are permitted at anytime and the method may in rare cases the method of FIG. 3 simply display some inaccurate information.

The method FIG. 3 is described having only a single mounted-over object mounted over a single covered object. This is for clarity of explanation and not for limitation. In fact, may objects may be mounted at the same location in name space thereby resulting in a number of covered objects mounted over one another. Identifying objects that are obscured in the visible name space of a file system according to the present invention also includes identifying objects obscured by objects that are themselves obscured by other objects.

The method of FIG. 3 may be invoked by making an API function call in an obscured object identification engine such as for example GetMountedOverMountInformation( ). GetMountedOverMountInformation( ) operates to retrieve a data structure representing a mounted-over object in the visible name space of the file system, retrieve a data structure representing that the mounted-over object is mounted over a covered object that is obscured in the visible name space, and retrieve a data structure representing the covered object in dependence upon the data structure representing that the mounted-over object is mounted over the covered object.

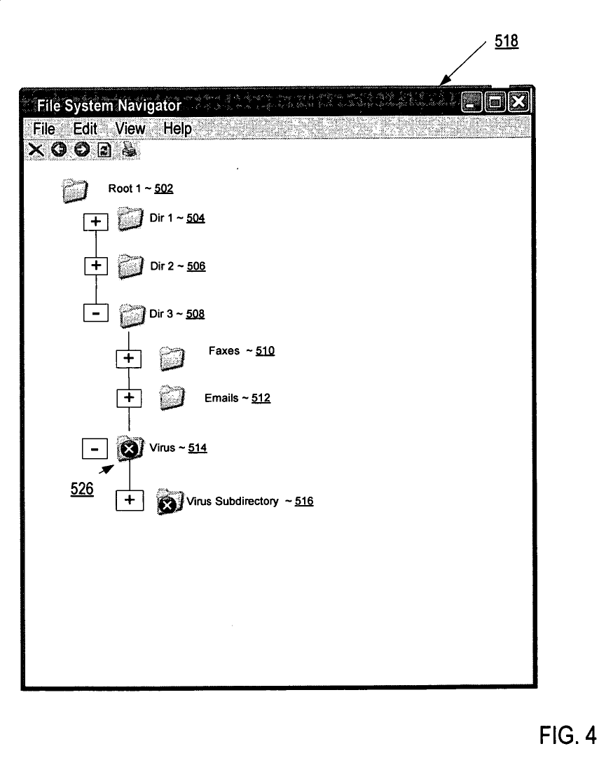

Displaying a GUI object for the covered object according to the method of FIG. 3 advantageously allows a user to view the obscured object. For further explanation therefore, FIG. 4 sets forth a block diagram of a GUI display of the visible name space of a file system whose covered objects are identified and displayed according to embodiments of the present invention. The GUI display (518) identifies with GUI objects a root directory (502) containing three subdirectories Dir 1 (504), Dir 2 (506), and Dir 3 (508). Subdirectory Dir 3 itself includes two subdirectories identified as Faxes (510) and Emails (512). In the example of FIG. 4, the subdirectory Dir 3 is mounted over a Virus (514) having itself a Virus subdirectory (516). In conventional displays of the visible name space, the virus (514) is obscured and therefore would not be displayed and therefore would be less likely to be discovered. Identifying objects that are obscured in the visible name space of a file system and displaying those objects advantageously provides users visual depictions of covered objects in the file system. In the example of FIG. 4, the covered virus (514) and its associated subdirectory (516) are displayed with a unique icon (526) identifying the objects as covered by the subdirectory Dir 3 and having been identified by embodiments of the present invention. In the example of FIG. 4, the covered objects are displayed without user instructions. In some embodiments however, the GUI display of FIG. 4 is modified to empower a user to select the option to view the covered objects and in such embodiments, the covered objects are only displayed in response to a user instruction to display the covered objects.

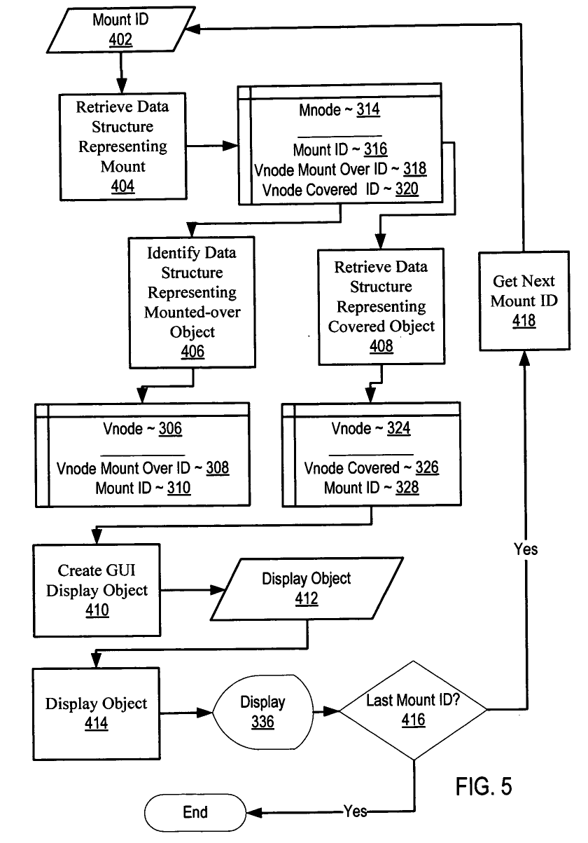

As discussed above, identifying objects that are obscured in the visible name space of a file system according to the exemplary method of FIG. 3 is carried out by retrieving a Vnode for each object identified by a pathname in the visible name space to identify whether the object is in fact mounted over another object. Retrieving a Vnode for every object in the visible name space may be tedious. For further explanation therefore, FIG. 5 sets forth a flow chart illustrating another exemplary method for identifying objects that are obscured in the visible name space of a file system. The method of FIG. 5 includes retrieving (404) a data structure (314) representing a mount in dependence upon a mount ID (402). Data structures representing a mount, that is, the mounting of the mounted-over objects over covered objects, in the i5/OS operating system are often called ‘mount private data’ and are called “Mnodes” in this specification for clarity of explanation. The exemplary Mnode of FIG. 5 represents a mount of a mounted-over object (306) over a covered object (324). The exemplary Mnode of FIG. 5 includes a Mount ID (316) uniquely identifying the mount. The exemplary Mnode of FIG. 5 also includes a Vnode Mount Over ID (318) uniquely identifying the Vnode of the mounted-over object and the Vnode Covered ID (320) uniquely identifying the Vnode of the covered object.

Retrieving (404) a data structure (314) representing a mount in dependence upon a mount ID (402) may be carried out by calling operating system functions such as, for example, getMountPrivateData() parameterized with a mount ID. Such functions return the Mnode identified by the mount ID if a matching Mnode is found. Sequential mount IDs or mount IDs having a perdetemined structure facilitate creating a loop to call all the mount IDs for the file system to retrieve Mnodes for all mounts on the file system.

The method of FIG. 5 includes identifying (406) a data structure (306) representing a mounted-over object in the visible name space of a file system in dependence upon the data structure (314) representing the mount. In the example of FIG. 5, the Mnode (314) identifies the Vnode representing the mounted-over object.

The method of FIG. 5 also includes retrieving (408) a data structure (324) representing a covered object that is obscured in the visible name space in dependence upon the data structure (314) representing the mount. In the example of FIG. 5, the Mnode (314) identifies the Vnode representing the covered object.

The exemplary Mnode (314) of FIG. 5 also identifies the mounted-over object through the Vnode Mount Over ID (318). The method of FIG. 5 also includes identifying a data structure (306) representing a mounted-over object in the visible name space of a file system in dependence upon data structure (314) representing a mount. In the example of FIG. 5, data structure (306) representing a mounted-over object in the visible name space of a file system is Vnode.

The method of FIG. 5 also includes creating (410) a GUI display object (412) representing the covered object; displaying (414) the GUI display object (412); and determining (416) whether the mount ID identifying the retrived Mnode is the last mount ID. If the mount ID identifying the Mnode is the last mount ID, then the method of FIG. 3 terminates. If there is another mount ID, the method of FIG. 5 continues by getting (418) the next mount ID. The method of FIG. 3 therefore retrieves a data structure representing each mount identified by a mount ID and identifies each covered object referenced in the data structure representing the mount and displays a GUI display object representing the covered object.

The method of FIG. 5 may provide an inaccurate display of covered objects if files are mounted or unmounted over covered objects before the completion of the method of FIG. 5. Identifying objects that are obscured in the visible name space of a file system according to the method of FIG. 5 may therefore include preventing mounts to the file system prior to retrieving the data structure representing the covered object. That is, in some embodiments of the method of FIG. 5, mounts to the file system are prevented until the method of FIG. 5 terminates. In other embodiments, mounts to the file system are prevented during each iteration of the method, which may occur periodically, thereby allowing mounts in between iterations of the method of FIG. 5. In still other embodiments, mounts are permitted at anytime and the execution of the method of FIG. 5 may in rare cases simply display inaccurate information.

The method of FIG. 5 may be invoked by calling an API function call in an obscured object identification engine such as SearchMountedOverMounts( ). SearchMountedOverMounts( ) operates for each mount ID identifying a mount to retrieve a data structure representing a mount in dependence upon a mount ID, retrieve a data structure representing a covered object that is obscured in the visible name space in dependence upon the data structure representing the mount, create a GUI display object representing the covered object, and display the GUI display object.

Exemplary embodiments of the present invention are described largely in the context of a fully functional computer system for identifying objects that are obscured in the visible name space of a file system. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for identifying objects that are obscured in the visible name space of a file system, the method comprising
retrieving a data structure representing a mount in dependence upon a mount ID; and
retrieving a data structure representing a covered object that is obscured in the visible name space in dependence upon the data structure representing the mount.

2. The method of claim 1 further comprising:
creating a GUI display object representing the covered object; and
displaying the GUI display object.

3. The method of claim 1 further comprising identifying a data structure representing a mounted-over object in the visible name space of a file system in dependence upon data structure representing a mount.

4. The method of claim 1 further comprising preventing mounts to the file system prior to retrieving the data structure representing the covered object.

5. An apparatus for identifying objects that are obscured in the visible name space of a file system, the apparatus comprising
a computer processor;
a computer memory coupled for data transfer to the processor, the computer memory having disposed within it a file system; and
computer program instructions comprising an obscured object identification engine comprising computer program instructions capable of:
retrieving a data structure representing a mount in dependence upon a mount ID; and
retrieving a data structure representing a covered object that is obscured in the visible name space in dependence upon the data structure representing a mount.

6. The apparatus of claim 5 wherein the obscured object identification engine further comprises computer program instructions capable of:
creating a GUI display object representing the covered object; and
displaying the GUI display object.

7. The apparatus of claim 5 wherein the obscured object identification engine further comprises computer program instructions capable of identifying a data structure representing a mounted-over object in the visible name space of a file system in dependence upon data structure representing a mount.

8. The apparatus of claim 5 wherein the obscured object identification engine further comprises computer program instructions capable of preventing mounts to the file system prior to retrieving the data structure representing the covered object.

9. A computer program product for identifying objects that are obscured in the visible name space of a file system the computer program product disposed upon a signal bearing medium, the computer program product comprising:
computer program instructions that retrieve a data structure representing a mounted-over object in the visible name space of the file system;
computer program instructions that retrieve, in dependence upon the data structure representing the mounted-over object, a data structure representing that the mounted-over object is mounted over a covered object that is obscured in the visible name space; and
computer program instructions that retrieve a data structure representing the covered object in dependence upon the data structure representing that the mounted-over object is mounted over the covered object.

10. The computer program product of claim 9 wherein the signal bearing medium comprises a recordable medium.

11. The computer program product of claim 9 wherein the signal bearing medium comprises a transmission medium.

12. The computer program product of claim 9 further comprising:
computer program instructions that create a GUI display object representing the covered object; and
computer program instructions that display the GUI display object.

13. The computer program product of claim 9 further comprising computer program instructions that prevent mounts to the file system prior to retrieving the data structure representing the covered object.

14. A computer program product for identifying objects that are obscured in the visible name space of a file system, the computer program product comprising
computer program instructions that retrieve a data structure representing a mount in dependence upon a mount ID; and
computer program instructions that retrieve a data structure representing a covered object that is obscured in the visible name space in dependence upon the data structure representing the mount.

15. The computer program product of claim 14 wherein the signal bearing medium comprises a recordable medium.

16. The computer program product of claim 14 wherein the signal bearing medium comprises a transmission medium.

17. The computer program product of claim 14 further comprising computer program instructions that create a GUI display object representing the covered object; and
computer program instructions that display the GUI display object.

18. The computer program product of claim 14 further comprising computer program instructions that identify a data structure representing a mounted-over object in the visible name space of a file system in dependence upon data structure representing a mount.

19. The computer program product of claim 14 further comprising computer program instructions that prevent mounts to the file system prior to retrieving the data structure representing the covered object.
